(19) United States
(12) Patent Application Publication
(10) Pub. No.: US 2014/0373003 A1
(43) Pub. Date: Dec. 18, 2014

(54) APPLIANCE-BASED FIRMWARE UPGRADE SYSTEM

(71) Applicant: L'Oreal, Paris (FR)

(72) Inventors: Joseph Grez, North Bend, WA (US); Kenneth Pilcher, Seattle, WA (US); Scott Straka, Kirkland, WA (US)

(73) Assignee: L'Oreal, Paris (FR)

(21) Appl. No.: 13/917,221

(22) Filed: Jun. 13, 2013

(51) Int. Cl. G06F 9/445

(52) U.S. Cl. CPC G06F 8/65
USPC 717/172

(57) ABSTRACT

An electronic appliance having control firmware includes an operating part which requires periodic replacement for effective operation of the appliance. The replacement operating part has an RFID tag attached thereto which includes updated firmware for the appliance. The appliance further includes an RFID reader which reads the updated firmware on the RFID tag when the replacement part is operatively positioned in the appliance, and updates/replaces the existing firmware or a portion thereof with the read firmware.

### TECHNICAL FIELD

This invention relates generally to consumer electronic products, particularly power skin brushes, which have a microprocessor and firmware controlling the operation of the appliance, and more specifically concerns a system for updating the firmware in the appliance.

### BACKGROUND OF THE INVENTION

Many electronic consumer products include microprocessors and firmware for control of the operation of the appliance. The distinguishing feature of a new product is often firmware-based. In addition, in such firmware-based appliances, updates are often required to correct code errors in the installed firmware. Firmware updates also prevent premature disposal of an appliance which otherwise would become operationally out of date.

Conventional firmware updating systems include downloading new firmware from discs, USB cards or wirelessly. However, in each case, the firmware update requires some technical knowledge and decisions to be made by the user. There are many advantages to updating existing skincare appliances controlled by firmware. However, it is known that users may not wish to go through the expense and/or trouble to update their skincare appliance. Further, existing methods of updating firmware require connections that can result in environmental exposure to the internal structure of the appliance, or require additional equipment or require a wireless communication means which uses security codes. All of these arrangements are typically too complicated to justify a simple skincare appliance update.

Accordingly, it is desirable to provide a substantially automatic system of updating skincare appliance firmware that requires no additional hardware or user interaction.

### DISCLOSURE OF THE INVENTION

Accordingly, a system for updating firmware in electronic consumer appliances comprises: an electronic appliance having existing firmware for operational control of the appliance and an operating part which requires periodic replacement for proper operation of the appliance; a replacement operating part having an RFID (radio frequency identification) tag which includes updated firmware for the appliance; and an RFID reader in the appliance which reads the firmware on the RFID tag and uses the read firmware to replace a corresponding part of the existing firmware.

Further, a replacement part for an electronic skin brush appliance which includes a handle portion having an RFID (radio frequency identification) reader and a microprocessor with existing firmware for control of the operation of the skin brush appliance, the replacement part comprises: a brushhead member adapted for replacement of an existing brushhead member used in the appliance, wherein the brushhead member includes an RFID tag, readable by the RFID reader in the handle, wherein the read firmware is used to replace the existing firmware or a portion thereof.

Still further, a system for updating firmware in electronic consumer devices, comprises: an electronic appliance having existing firmware for operational control and an operating part which requires periodic replacement for proper operation, the operating part having an RFID tag containing firmware for the appliance; and a mobile communication device having an RFID reader capable of reading the RFID tag on the operating part and capable of communicating with a remote website which includes 8updated firmware which can be obtained and loaded back to the mobile communication device and then to the RFID tag on the operating part, to permit additional functionality for the appliance.

### BRIEF DESCRIPTION OF THE DRAWINGS

FIG. 1 is a perspective view of a power skin brush.

FIG. 2 is an exploded/cross-sectional view of the system of the present invention embodied in a skincare appliance.

FIG. 3 is a view of accessible memory areas in the reprogrammable microprocessor of FIG. 1.

FIG. 4 is a diagram of the system of FIG. 2 in an ecommerce application.

### BEST MODE FOR CARRYING OUT THE INVENTION

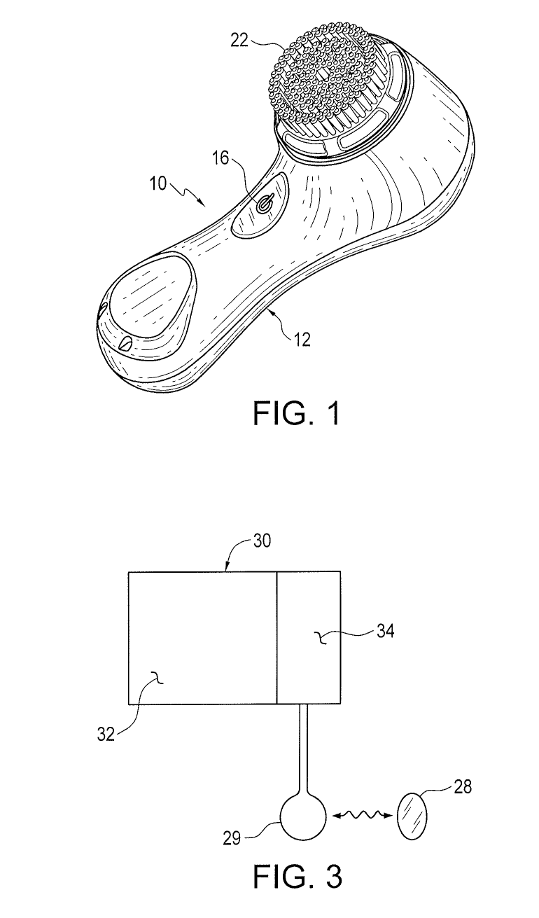

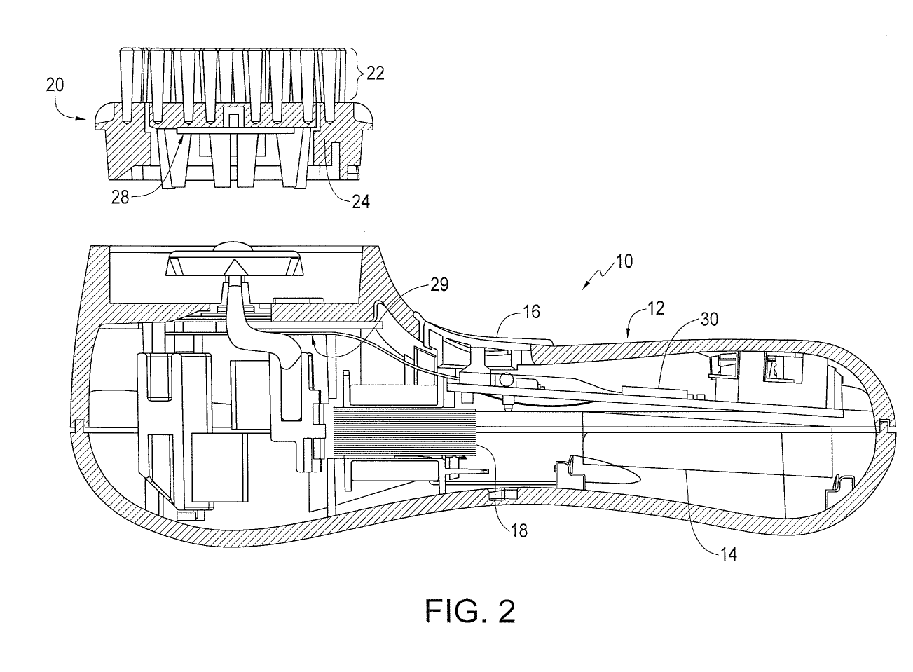

FIG. 1 is a perspective view of a power skin brush appliance, while FIG. 2 is an exploded/cross-section of the skincare appliance, referred to generally at 10. The appliance includes a handle or appliance housing 12. The appliance is powered by a battery 14, with an external charger (not shown). The appliance 10 includes an on/off switch 16, which controls a motor 18 which operates a workpiece 20. In the appliance shown, workpiece 20 is a brush assembly having a set of bristle tufts 22 mounted to a bristle base 24. The set of bristle tufts can have a variety of configurations. The brush assembly has in operation a useful life, at the end of which the bristle tufts become worn, at which point the brush assembly should be replaced. With typical use, this will occur at approximately three-month to six-month intervals. In one embodiment, the brush assembly is under the control of motor 18, by a microprocessor 30, oscillating in a back-and-forth motion, with an angle of approximately 7° and a frequency within the range of 150-250 Hz. This is illustrative of a particular embodiment of a power skin brush; it should be understood that the invention disclosed herein is not limited to such an embodiment.

In the present invention, an RFID (radio frequency identification) tag 28 is attached to the workpiece. The RFID tag can be in various positions on the replaceable workpiece, but in the embodiment shown is attached to the underside of the inner base 24. The RFID tag contains the upgraded firmware for the appliance. The tag is otherwise conventional, approximately 18 mm by 18 mm in the embodiment shown. The upgraded firmware may include improved performance control/code for the appliance, corrected codes for operation of the appliance, and/or other purposes. The appliance includes an RFID reader antenna 29 positioned in the appliance so that it can read the RFID tag on the replaceable workpiece.

The upgraded firmware read by the RFID reader is then transmitted to the reprogrammable microprocessor 30 positioned within the appliance. FIG. 3 shows a generalized arrangement of accessible areas of memory in the reprogrammable microprocessor 30. Operational firmware is divided into two areas in the microprocessor. Updatable field 32 represents the firmware which operates the appliance during normal use and a non-updatable field 34 manages the information flow from the RFID tag on the workpiece to the reader antenna 29 and from there to the updatable field 32. The non-updatable field also manages the firmware updating process during restart functions as required.

This arrangement results in a firmware upgrading system which accomplishes upgrades at regular intervals, coincident with the replacement of the brushhead, without any action required by the user; in effect, almost an automatic upgrade. Typically, the upgrade will have an identification number such that the microprocessor will know whether or not to implement the upgrade, since it is possible that a particular replacement brushhead or other workpiece may contain an earlier version of the firmware than is present and operating in the microprocessor.

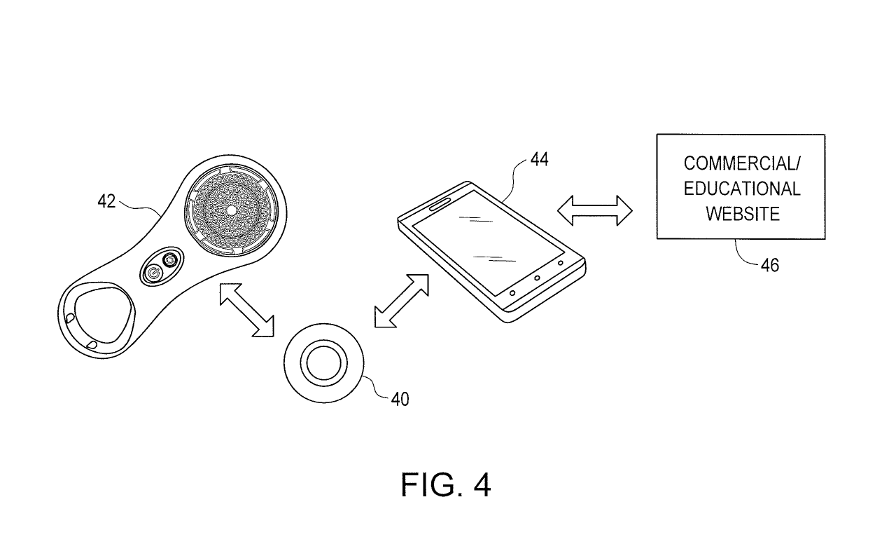

Referring now to FIG. 4, RFID tagged brushes 40 for a skin care appliance 42 are readable by mobile devices 44, such as smartphones and tablets, among other devices equipped with embedded RFID readers, to enable ecommerce activity, such as communication with a commercial website 46. The RFID tag on the replaceable brushhead, upon being read by the mobile device, directs the device to a particular website through its URL. The website 46 will include various information, including purchase of replacement brushheads, new skin treatment formulations which are specific to specific brushes and even customer-specific formulation/brush combinations. The website may include updated firmware which can be downloaded to the mobile device and then to the RFID tag, to be read by the reader in the handle. Specialized and newly developed skin treatment protocols may be viewed and/or purchased from the website as well, with the purchase of protocols being directly downloadable to the user's mobile device 44 and from there loaded onto the RFID tag on the brushhead in the appliance 42 to provide additional functionality for the appliance. This will typically be part of a general firmware upgrade, although it could be an addition to the existing firmware.

Further, available tracking information/capability may be used to identify specific users of the appliance, so that targeted promotional offers can be directed to the user's specific mobile device. The website can also enhance timely brush replacement by providing reminders/notifications to the user's smartphone, mobile devices or other similar device.

Further, the camera capability of a typical mobile device may be used to record areas of a user's face for transmittal to a website accessible by skin treatment professions and/or clinicians for assessment and recommendation of specific brush formulations, or even a virtual web chat, in which a remote clinician can assess the users' photos and provide direct recommendations.

The RFID tag on a brushhead can also be used to direct the mobile device user to an educational website which provides educational information, including newly available brushes, formulations, cleansing protocols and cosmetic techniques for the particular brush or appliance combination.

An appliance itself (the handle portion, for instance) can be used to scan both an RFID tagged brush, and an RFID tagged formulation. This appliance may then unlock new cleansing protocols present in the RFID tags or the handle which are specifically relevant to or coordinated with the brush/formulation previously scanned. One example of such a system would be a pedicure device which scans both a pedi scrub formulation and a pedi brush member and which then operates at a predefined specific frequency, power level and operational profile available in the RFID tags on the appliance to deliver optimal effects relative to a specific formulation.

The appliance itself can also be used to scan cosmetic formulations with an RFID tag having a temporary authorization code, which enables the appliance to operate a specific cleansing protocol for a fixed or limited amount of time. Such a system could be used to provide a trial use of the new formulation/protocol combination, thereafter requiring purchase of a quantity of the formulation to permanently unlock the protocol in the appliance.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. A system for updating firmware in electronic consumer appliances, comprising:
an electronic appliance having existing firmware for operational control of the appliance and an operating part which requires periodic replacement for proper operation of the appliance;
a replacement operating part having an RFID (radio frequency identification) tag which includes updated firmware for the appliance; and
an RFID reader in the appliance which reads the firmware on the RFID tag and uses the read firmware to replace a corresponding part of the existing firmware.

2. The system of claim 1, wherein the updated firmware includes improved operational control of the appliance.

3. The system of claim 1, wherein the updated firmware includes correction of errors in the existing firmware.

4. The system of claim 1, wherein the appliance is a power skin brush.

5. The system of claim 4, wherein the replacement part is a brush portion of the appliance.

6. The system of claim 5, wherein the RFID tag is not visible when the brush portion is in an operating position in the appliance.

7. A replacement part for an electronic skin brush appliance which includes a handle portion having an RFID (radio frequency identification) reader and a microprocessor with existing firmware for control of the operation of the skin brush appliance, the replacement part comprising:
a brushhead member adapted for replacement of an existing brushhead member used in the appliance, wherein the brushhead member includes an RFID tag, readable by the RFID reader in the handle, wherein the read firmware is used to replace the existing firmware or a portion thereof

8. The replacement part of claim 7, wherein the replacement firmware includes changes and/or updates to the existing firmware.

9. The replacement part of claim 7, wherein the RFID tag is not visible when the brushhead member is in an operating position in the appliance.

10. A system for updating firmware in electronic consumer devices, comprising:
an electronic appliance having existing firmware for operational control and an operating part which requires periodic replacement for proper operation, the operating part having an RFID tag containing firmware for the appliance; and
a mobile communication device having an RFID reader capable of reading the RFID tag on the operating part and capable of communicating with a remote website which includes 8updated firmware which can be obtained and loaded back to the mobile communication device and then to the RFID tag on the operating part, to permit additional functionality for the appliance.

11. The system of claim 10, wherein the appliance is a power skin brush and the operating part is a replaceable brushhead.

12. The system of claim 10, wherein the mobile device is a smartphone or tablet.

13. The system of claim 11, wherein the website includes additional specialized protocols adapted for a user, either part of the updated firmware or an addition thereto.
